(19) United States
(12) Patent Application Publication
(10) Pub. No.: US 2010/0057988 A1
(43) Pub. Date: Mar. 4, 2010

(54) STORAGE SYSTEM AND METHOD FOR MANAGING CONFIGURATION THEREOF

(76) Inventors: Takeki Okamoto, Odawara (JP); Mikio Fukuoka, Odawara (JP)

Correspondence Address: BRUNDIDGE & STANGER, P.C., 1700 DIAGONAL ROAD, SUITE 330, ALEXANDRIA, VA, 22314, US

(21) Appl. No.: 12/253,570

(22) Filed: Oct. 17, 2008

(30) Foreign Application Priority Data
Aug. 27, 2008 (JP) 2008-217801

(51) Int. Cl. G06F 12/00; G06F 12/02; G06F 12/16

(52) U.S. Cl. 711/114; 711/162; 711/170; 711/E12.001; 711/E12.002; 711/E12.103

(57) ABSTRACT

In a storage system having a plurality of storage devices, erasing frequencies of the storage devices with a limit of the number of erasures are made uniform.

In a storage system for storing data, comprising a plurality of storage devices for storing the data, the plurality of storage devices comprising spare storage devices, and the storage system comprises an identifier of each of the storage devices and storage device configuration information having a number of erasures of data that data stored in each storage device is erased, and copies data stored in a storage device whose number of erasures of data exceeds a predetermined first threshold value to the spare storage device in a case where the number of erasures of data exceeds the predetermined first threshold value, and allocates an identifier of the storage device number of erasures of data exceeds the predetermined first threshold value to an identifier of the spare storage device which the data has been copied to.

### CROSS REFERENCES TO RELATED APPLICATIONS

This application relates to and claims priority from Japanese Patent Application No. 2008-217801, filed on Aug. 27, 2008, the entire disclosure of which is incorporated herein by reference.

### BACKGROUND OF THE INVENTION

1. Field of the Invention

The present invention relates to a technique to manage a configuration of a storage system having a plurality of storage devices.

2. Description of the Background Art

In order to update data in a storage device configured of a semiconductor storage medium such as a flash memory, after first erasing all of areas (blocks) storing data of the update target, data which will be updated is required to be written thereinto. A representative of such storage device is an SSD (Solid State Drive), for example.

Further, the flash memory used as the SSD has a limit on the number of erasures of data, and it cannot store data if the number of erasures exceeds the erasure limit. Therefore, a technique is disclosed in Patent Document 1 in which the lifetime of a storage device is lengthened by uniformizing the number of erase operations by allocating data such that update (erasing) of data does not become concentrated on a specific area of memory provided by SSD.

Patent Document 1: Japanese Patent Application Laid-open No. 2007-149241

### SUMMARY OF THE INVENTION

The technique disclosed in Patent Document 1 can uniformize the number of erasures (writings) for storage areas provided by the same storage device, but it does not discuss the uniformization of the number of erasures per storage device in respect to a storage system including a plurality of storage devices. For example, when a RAID group is configured by a plurality of SSDs and application of a RAID technology (for example, RAID 5), the number of erasures cannot be made uniform among the SSDs.

For example, data stored in memory areas provided by the RAID group are memorized by a plurality of striped storage devices, and, if the data is smaller than a stripe size and is read or written locally, input and output thereof are concentrated on a specific storage device.

Thus, when a variation of the number of erasures among storage devices included in the storage systems occurs, lifetimes for the respective storage devices begin to deviate from one another, even though the number of erasures in the storage areas provided by the storage device was uniformized. For this reason, a lifetime of the entire storage system may shorten, or the operation cost may increase due to the increase in the frequency of replacing storage devices included in the storage system.

The present invention is directed to intend to lengthen the lifetime of an entire storage system and reduce the operation cost, by uniformizing the number of erasures of the storage device included in a storage system.

In a representative embodiment of the present invention, a storage system for storing readable and writable data, includes: an interface; a processor connected to the interface; a memory connected to the processor; and a plurality of storage devices for storing the data, wherein the plurality of storage devices comprise spare storage devices, the memory stores an identifier of each of the storage devices and storage device configuration information having a number of erasures of data in which the data stored in each storage device was erased, and the processor copies data stored in a storage device whose number of erasures of data exceeds a predetermined first threshold value to the spare storage device in a case where the number of erasures of data exceeds the predetermined first threshold value, and allocates an identifier of the storage device whose number of erasures of data exceeds the predetermined first threshold value to an identifier of the spare storage device which the data has been copied to.

According to an embodiment of the present invention, a storage device with a large number of erasures of data is replaced with a spare storage device, to uniformize the number of erasures of the storage devices and to lengthen the lifetime of the entire storage system.

### BRIEF DESCRIPTION OF THE DRAWINGS

FIG. 1 is a diagram to illustrate a configuration of a computer system according to the first embodiment of the present invention;

FIG. 2 is a diagram to illustrate information stored in the shared memory according to the first embodiment of the present invention;

FIG. 3 is a diagram to illustrate an example of the message table according to the first embodiment of the present invention;

FIG. 4 is a diagram to illustrate an example of the request-response content table according to the first embodiment of the present invention;

FIG. 5 is a diagram to illustrate an example of the RAID group information table according to the first embodiment of the present invention;

FIG. 6 is a diagram to illustrate an example of the drive information table according to the first embodiment of the present invention;

FIG. 7 is a diagram to illustrate an example of a configuration of the disk adaptor according to the first embodiment of the present invention;

FIG. 8 is a flowchart to illustrate an order to accept the writing request of data from the host computer and to write the data into the storage devices according to the first embodiment of the present invention;

FIG. 9 is a diagram to illustrate a flow of a processing to write data into the storage devices according to the first embodiment of the present invention;

FIG. 10 is a flowchart to illustrate the order of writing the message into the shared memory, in order to store the data stored in the cache into the storage devices, according to the first embodiment of the present invention;

FIG. 11 is a flowchart to illustrate an order of reading the data stored in the storage devices into the cache, based on the message stored in the shared memory, according to the first embodiment of the present invention;

FIG. 12 is a flowchart to illustrate an order of writing the data stored in the cache into the storage devices based on the message stored in the shared memory according to the first embodiment of the present invention;

FIG. 13 is a flowchart to illustrate an order of updating the number of erasures of the drive information table according to the first embodiment of the present invention;

FIG. 14 is a diagram to illustrate a flow of data upon performing the dynamic sparing according to the first embodiment of the present invention;

FIG. 15 is a flowchart to illustrate an order of performing the dynamic sparing according to the first embodiment of the present invention;

FIG. 16 is a flowchart to illustrate an order of replacing the storage devices included in the storage system according to the first embodiment of the present invention;

FIG. 17 is a diagram to illustrate an order of storing the number of erasures of each storage device in the configuration information area according to the second embodiment of the present invention;

FIG. 18 is a flowchart to illustrate an order of performing the dynamic sparing according to the second embodiment of the present invention;

FIG. 19 is a diagram to illustrate an order of storing the number of erasures of each storage device in the configuration information area according to the third embodiment of the present invention; and

FIG. 20 is a flowchart to illustrate an order of performing the dynamic sparing according to the third embodiment of the present invention.

### DETAILED DESCRIPTION OF THE PREFERRED EMBODIMENTS

The present invention intends to lengthen the lifetime of an entire storage system by uniformizing the number of writings (erasures) of storage devices including spare storage devices in a storage system comprised of semiconductor storage media with limits to the number of writings such as flash memory and soon. As an example of uniformizing the number of writings, the number of writings for each storage device is recorded, and the data stored in the storage device with a high number of writings is transferred to the storage device in the spare storage device (dynamic sparing). Hereinafter, embodiments of the present invention will be described in detail with reference to drawings.

### First Embodiment

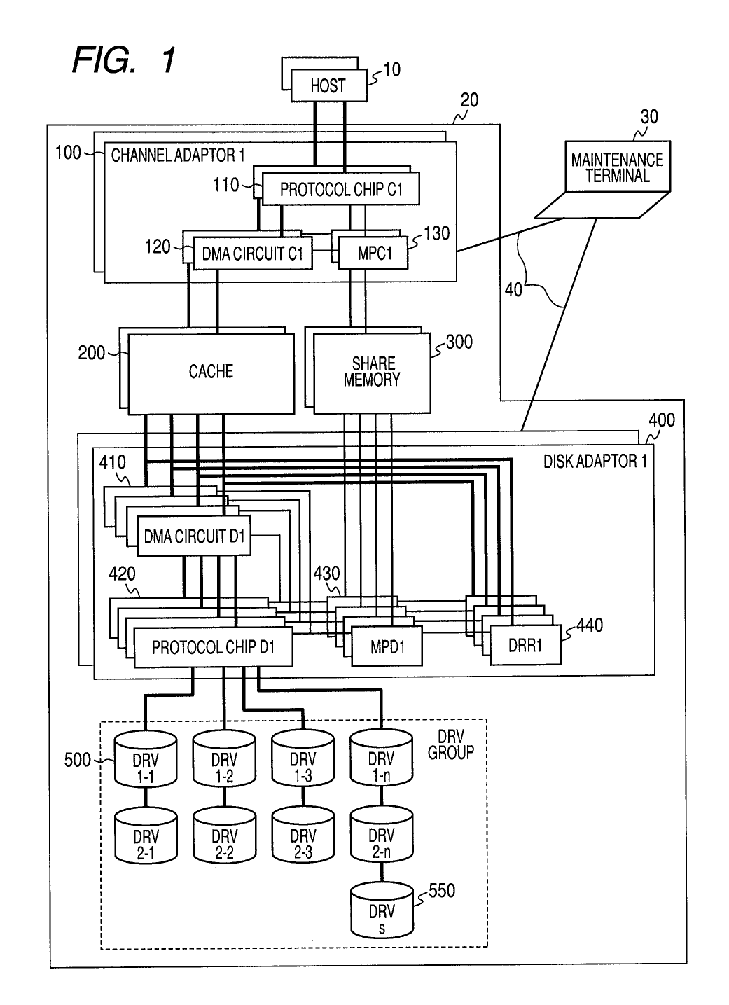

FIG. 1 is a diagram to illustrate a configuration of a computer system according to a first embodiment of the present invention.

The computer system according to the first embodiment of the present invention includes a host computer 10, a storage system 20 and a maintenance terminal 30.

The host computer 10 runs application programs and processes a variety of tasks by use of data stored in the storage system 20. The storage system 20 stores data read and written by the host computer 10. The host computer 10 is configured of hardware possible to be realized by a general computer (PC).

The storage system 20 includes a plurality of storage devices 500 and stores data read and written by the host computer 10.

The storage system 20 includes a channel adaptor 100, a cache 200, a shared memory 300, a disk adaptor 400 and the storage devices 500.

The channel adaptor 100 includes an interface connected to external devices and controls transmission/reception of data to/from the host computer 10. The channel adaptor 100 is connected to the cache 200 and the shared memory 300. The channel adaptor 100 includes a protocol chip 110, a DMA circuit 120 and an MP 130. The protocol chip 110, the DMA circuit 120 and the MP 130 are connected to one another. The protocol chip 110, the DMA circuit 120 and the MP 130 are multiplexed, respectively. In a case of describing a common function or a processing, the protocol chip 110, the DMA circuit 120 and the MP 130 are denoted; in contrast, in a case of describing a separate processing, C1 to Cn are added to the reference signs thereof. For example, an MPC1 is denoted.

The protocol chip 110 includes a network interface and is connected to the host computer 10. The protocol chip 110 transmits and receives data from and to the host computer 10 and performs a protocol control and the like.

The DMA circuit 120 controls a processing of transmitting data to the host computer 10. In detail, it controls a DMA transmission between the protocol chip 110 and the cache 200 connected to the host computer 10. The MP 130 controls the protocol chip 110 and the DMA circuit 120.

The cache 200 stores data read and written by the host computer 10 temporarily. The storage system 20 provides data stored in the cache 200, not data stored in the storage device 500, to enable a high-speed data access, in a case where data requested by the host computer 10 are stored in the cache 200.

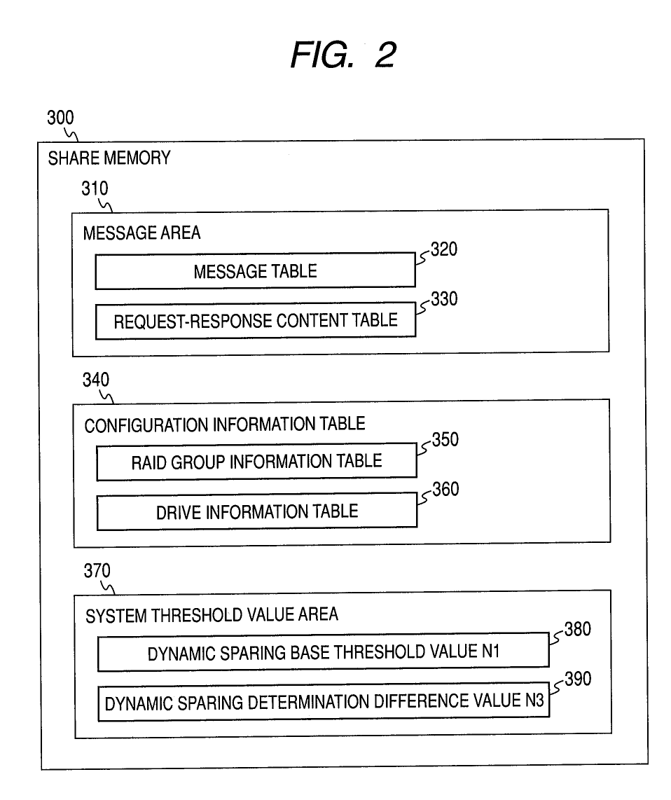

The shared memory 300 memorizes information required for a processing or a control by the channel adaptor 100 and a disk adaptor 400. For example, a communication message processed by the channel adaptor 100 or the disk adaptor 400 and configuration information for the storage system 20 are memorized therein. Details of the information stored in the shared memory 300 will be described in detail later in FIG. 2.

The disk adaptor 400 includes an interface connected to the storage device 500 and controls transmission and reception of data from and to the cache 200. The disk adaptor 400 includes a DMA circuit 410, a protocol chip 420, an MP 430 and a DDR 440. The DMA circuit 410, the protocol chip 420, the MP 430 and the DDR 440 are connected to one another. In addition, the DMA circuit 410, the protocol chip 420, the MP 430 and the DDR 440 are multiplexed, respectively. In a case of describing a common function or a processing, the DMA circuit 410, the protocol chip 420, and the MP 430 are denoted; in contrast, in a case of describing a separate processing, D1 to Dn are added to the reference signs thereof. For example, an MPD1 is denoted.

The DMA circuit 410 controls a DMA transmission between the protocol chip 420 and the cache 200. The protocol chip 420 includes an interface connected to the storage device 500 and performs a protocol control between the storage device 500 and itself.

The MP 430 controls the DMA circuit 410, the protocol chip 420, and a DDR 440. The DDR 440 reads data stored in the cache 200, creates redundant data, and writes the created redundancy data into the cache 200.

The storage device 500 stores data read/written by the host computer 10. In the first embodiment of the present invention, the storage device 500 is an SSD configured of flash memory. In a case of describing a common content of the respective storage devices 500, the storage device 500 is denoted; in contrast, in a case of describing the separate storage device 500, an appropriate identifier is added thereto such as a storage device 500A.

In addition, the storage system 20 according to the first embodiment of the present invention configures a RAID group by a plurality of storage devices 500 and creates redundancy data for storage. The storage system 20 includes a spare storage device 550 for making preparation against an obstacle. In addition, the spare storage device 550 is replaced with the storage device 500 by the dynamic sparing or the like.

The maintenance terminal 30 is a terminal for maintaining the storage system 20 and is connected to the storage system 20 via the network 40. In detail, the maintenance terminal 30 is connected to the channel adaptor 100 and the disk adaptor 400 included in the storage system 20, and maintains the storage system 20. In addition, the maintenance terminal 30 is configured of hardware possible to be realized by a general computer (PC) like the host computer 10.

FIG. 2 is a diagram to illustrate information stored in the shared memory 300 according to the first embodiment of the present invention.

The shared memory 300 includes a message area 310, a configuration information area 340 and a system threshold value area 370.

The message area 310 stores a message including an instruction required for processing. The message area 310 stores a message for carrying out the processing to maintain or administer the storage system 20, in addition to a message for performing a processing requested by the host computer 10. The messages stored in the message area 310 are processed by the channel adaptor 100 or the disk adaptor 400. In detail, the message area 310 stores a message table 320 and a request-response content table 330.

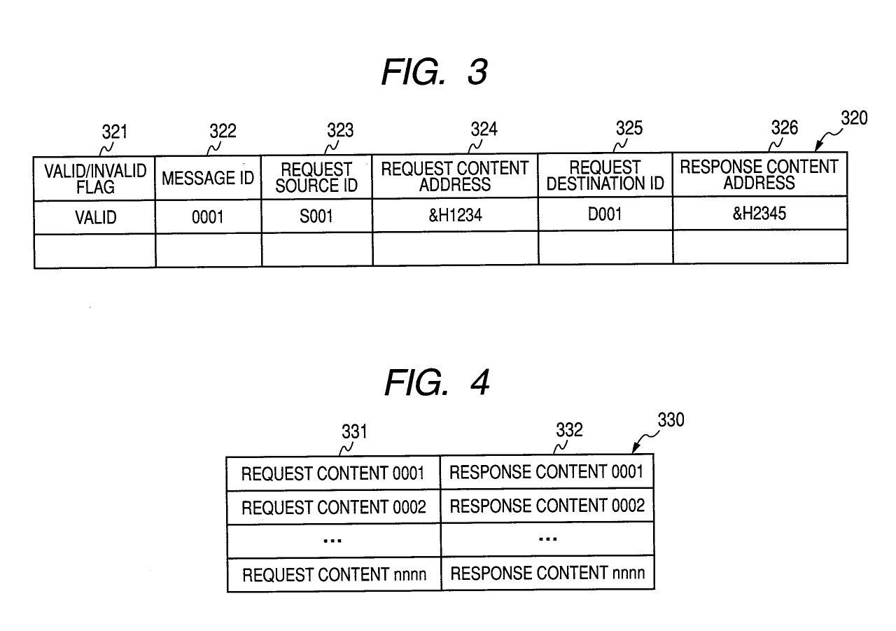

The message table 320 stores information that indicates the identification information of the request source and request destination, request content, and the response content. The message table 320 will be described in detail later in FIG. 3.

The request-response content table 330 stores a detailed content of a message indicative of the request content and the response content. The request-response content table 330 will be described in detail later in FIG. 4.

The configuration information area 340 stores information for the configuration information of the RAID group, which consist of the storage devices 500, and information for the storage devices 500. In detail, the configuration information area 340 stores the RAID group information table 350 and the drive information table 360 as storage device configuration information.

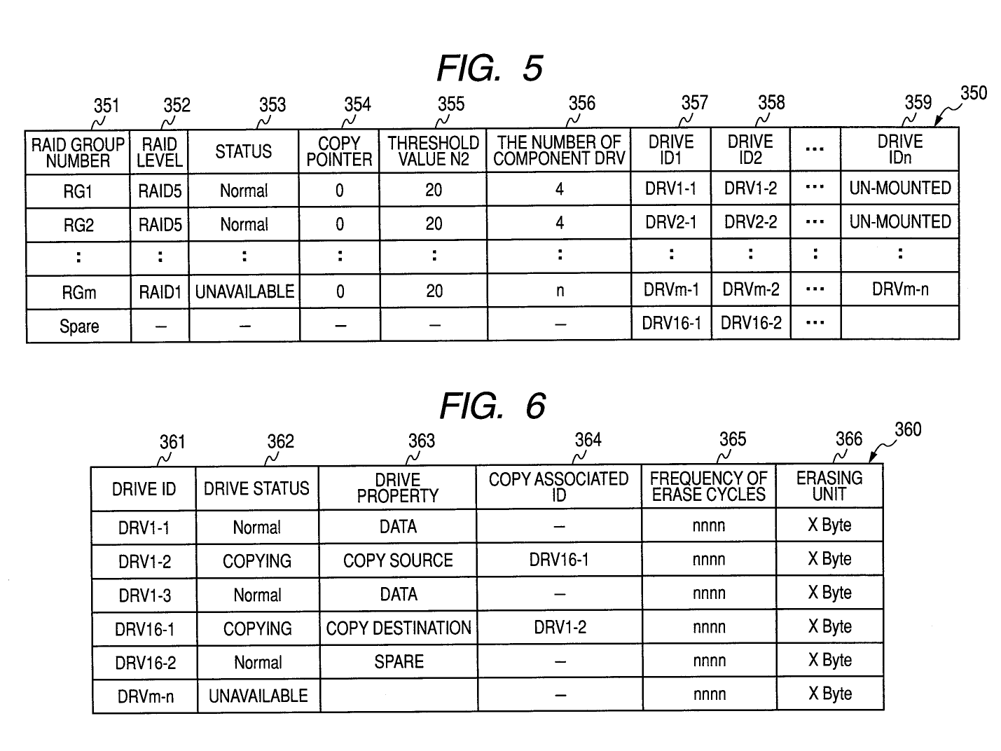

The RAID group information table 350 includes information for the RAID group and the storage devices 500 configuring the corresponding RAID group and such. The RAID group information table 350 will be described in detail later in FIG. 5.

The drive information table 360 stores information such as a property and a status of the storage devices 500. The driver information table 360 will be described in detail later in FIG. 6.

The system threshold value area 370 includes a dynamic sparing base threshold value N1 (380) and a dynamic sparing determination difference value N3 (390).

The dynamic sparing base threshold value N1 380 is a common system value for determining whether or not the dynamic sparing is performed. In the first embodiment, a threshold value is defined for each RAID group, based on a configuration of the RAID group and the dynamic sparing base threshold value N1 (380).

The dynamic sparing determination difference value N3 (390) is a threshold value used for switching the storage devices 500 based on a difference of the number of erasures of the storage devices 500. The dynamic sparing determination difference value N3 (390) is also used as a third embodiment described later.

The dynamic sparing base threshold value N1 (380) and the dynamic sparing determination difference value N3 (390) can be updated by the maintenance terminal 30.

FIG. 3 is a diagram to illustrate an example of the message table 320 according to the first embodiment of the present invention.

The message table 320 includes request content corresponding to a message and response content for the corresponding request. In detail, the message table 320 includes a valid/invalid flag 321, a message ID 322, a request source ID 323, a request content address 324, a request destination ID 325 and a response content address 326.

The valid/invalid flag 321 is a flag indicative of whether a message is valid or invalid. The message ID 322 is an identifier for identifying a message at one time.

The request source ID 323 is an identifier for identifying a request source to make request for a processing included in a message. For example, when a content of the message is a request for reading data about the storage system 20 from the host computer 10, an identifier of the MP 130 of the channel adaptor 100 to accept the request is stored.

The request content address 324 is an address of an area where request content is memorized. The request content itself is stored in the request-response content table 330 described later and only an address is stored in the request content address 324.

The request destination ID 325 is an identifier for identifying a request destination of the processed request included in a message. As described above, for example, when a content of the message is a request for reading data about the storage system 20 from the host computer 10, an identifier of the MP 430 of the disk adaptor 400 that processes the request is stored.

The response content address 326 is an address of an area where response content is memorized. The response content itself is stored in the request-response content table 330 described later, like the request content.

FIG. 4 is a diagram to illustrate an example of the request-response content table 330 according to the first embodiment of the present invention.

The request-response content table 330 stores entities of the request content 331 and the response content 332. The message table 320 stores addresses of the areas where the request content 331 and the response content 332 are stored, as described above.

The request content 331 includes a processing content requested by the host computer 10 and the like. In detail, the request content 331 includes information indicative of whether the request content is a reading or a writing of the data, an address of the cache 200 storing the corresponding data, a logical address of the storage device 500, and a transmission length of the data. The response content 332 includes information for data to be transmitted to the request source.

FIG. 5 is a diagram to illustrate an example of the RAID group information table 350 according to the first embodiment of the present invention.

The RAID group information table 350 stores information for definition of the RAID group configured of the storage devices 500 included in the storage system 20.

The RAID group information table 350 includes a RAID group number 351, a RAID level 352, a status 353, a copy pointer 354, a threshold value N2 (355), a number of component DRV 356, and drive IDs (357 to 359).

The RAID group number 351 is an identifier of a RAID group. The RAID level 352 is a RAID level of a RAID group identified by the RAID group number 351. In detail, “RAID1,” “RAID5” and the like are stored.

The status 353 represents a status of the corresponding RAID group. For example, when the RAID group is operated normally, “Normal” is stored, and, when the RAID group is unavailable due to an obstacle, “Unavailable” is stored.

The copy pointer 354 stores an address of an area where a copy is completed, when the storage device 500 included in a RAID group is copied to another storage device in a case where the dynamic sparing is performed.

The threshold value N2 (355) is a threshold value defined for each RAID group, and the dynamic sparing is performed for the corresponding storage device 500 in which the number of erasures included in the corresponding RAID group exceeds the threshold value N2. In addition, the threshold value N2 (355) can be updated by the maintenance terminal 30.

The number of DRV 356 is a number of the storage devices 500 configuring a RAID group. The drive IDs (357 to 359) are identifiers of the storage devices 500 configuring a RAID group.

In addition, as in the entry “Spare” of the RAID group number 351, the storage device 500 which does not actually configure the above-mentioned RAID group may also be included. In this way, dynamic sparing can be carried out even on storage devices which do not belong to a RAID group by using the RAID group number 351 as identification information.

FIG. 6 is a diagram to illustrate an example of the drive information table 360 according to the first embodiment of the present invention.

The drive information table 360 stores information of the storage devices 500 included in the storage system 20. The drive information table 360 includes a drive ID 361, a drive status 362, a drive property 363, a copy associated ID 364, the number of erasures 365 and an erasing unit 366.

The drive ID 361 is an identifier of the storage device 500. The drive status 362 is information indicative of a status of the storage device 500. The drive status 362 stores “Normal” which represents the operating state, and “Copying” which represents that the storage device 500 is being copied to another storage device 500 or has been copied to another storage device by the dynamic sparing or the like.

The drive property 363 stores a property of the storage device 500. In detail, “Data” is stored in a case where data is stored, and “Copy source” or “Copy destination” is stored in a case of where the copy is proceeding. “Spare” is stored in a case where the storage device 500 is a spare drive.

The copy associated ID 364 stores a drive ID of a storage device 500 of the other party of the copy when the drive status is “Copying.” In detail, the drive ID 361 of a storage device 500 of a copy destination is stored in the copy associated ID 364 in a case where the device property is a copy source, and the drive ID 361 of a storage device 500 of a copy source is stored therein in a case where the device property is a copy destination.

The number of erasures 365 stores the number of times that an erasure process of data has been performed for a storage device 500 to be identified by the drive ID 361. As described above, since, in a case of writing data, the data is written after first erasing an area where the data will be written in the SSD, the number of erasures 365 is also referred to as the number of writings.

The erasing unit 366 is a size of an area where written data is erased in a case of writing data or the like. In addition, generally, the writing (erasing) unit is larger than a reading unit of data in the SSD. In the first embodiment of the present invention, the erasing unit of data may be different from or the same as the reading unit of data.

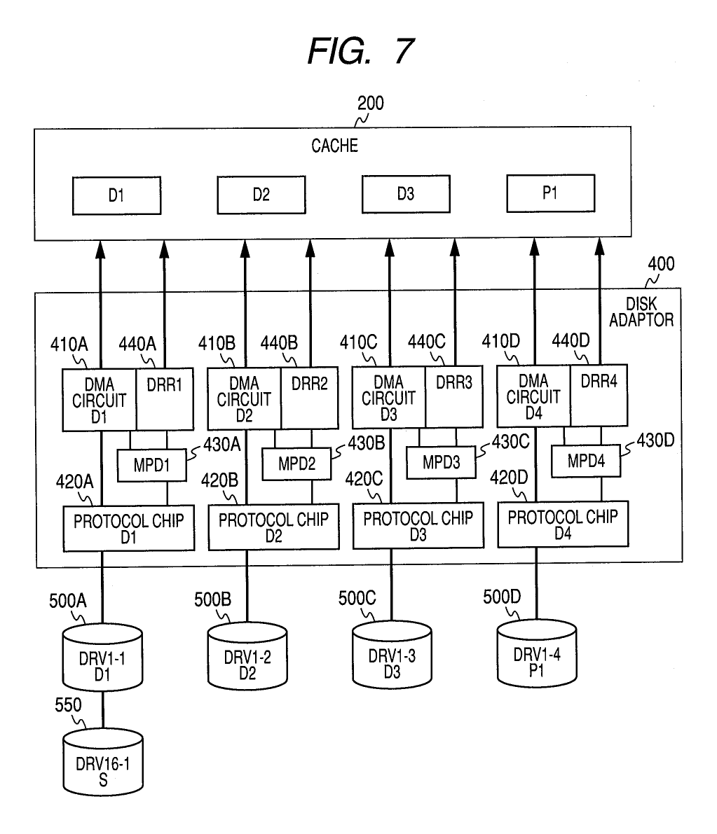

FIG. 7 is a diagram to illustrate an example of a configuration of the disk adaptor 400 according to the first embodiment of the present invention.

The disk adaptor 400 shown in FIG. 7 includes four DMA circuits D1 to D4 (410A to 410D), four DRR1 to DRR4 (440A to 440D), four protocol chips D1 to D4 (420A to 420D) and four MPD1 to MPD4 (430A to 430D).

The storage devices 500 (500A to 500D) configures a RAID group of 3D+1P. The storage device 500A is “DRV1-1” in the drive ID 361 and further is given “D1” as identification information within the RAID group. Likewise, the storage device 500B is “DRV1-21” in the drive ID 361 and further is given “D2” as identification information within the RAID group. The storage device 500C is “DRV1-3” in the drive ID 361 and further is given “D3” as identification information within the RAID group and the storage device 500D is “DRV1-4” in the drive ID 361 and further is given “P1” as a parity corresponding to identification information within the RAID group.

A storage device 500 whose drive ID 361 is “DRV16-1” may be allocated as a spare storage device 550. In addition, as described above, the RAID configuration information is defined in the RAID group information table 350 of the configuration information area 340 included in the shared memory 300.

The storage devices 500 are controlled by each set of the DMA circuits 410, the DDRs 440, the protocol chips 420 and the MPs 430. For example, the storage device 500A (D1) and the spare storage device 550 (S) are controlled by the DMA circuit D1 (410A), the DDR1 (440A), the protocol chip D1 (420A) and the MPD1 (430A).

Areas corresponding to the storage devices 500 are secured according to need in the cache 200. For example, the area “D1” is created in the storage device 500A in order to correspond to the identification information within the RAID group.

An order is described assuming that the respective storage devices 500 are controlled by the MPs 430 of the associated disk adaptor 400 and the management thereof is processed by the MPD1 (430A).

Hereinafter, an order to process a writing request of data transmitted to the storage system 20 by the host computer 10 will now be described.

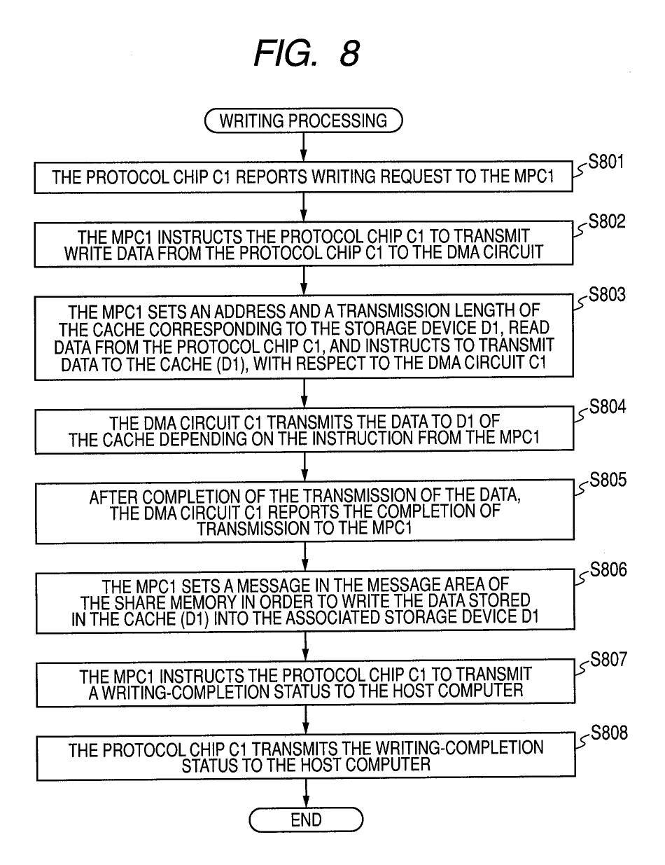

FIG. 8 is a flowchart to illustrate an order to accept the writing request of data from the host computer 10 and to write the data into the storage devices 500 according to the first embodiment of the present invention. In addition, this process will be described assuming that the protocol chip C1 (110) accepts the writing request of data transmitted from the host computer 10.

First, if accepting the writing request of data transmitted from the host computer 10, the protocol chip C1 (110) reports the acceptance of the writing request to the MPC1 (130) (S801).

If receiving the acceptance of the writing request, the MPC1 (130) instructs the protocol chip C1 (110) to transmit write data from the protocol chip C1 (110) to the DMA circuit C1 (120) (S802).

The MPC1 (130) further instructs the DMA circuit C1 (120) to transmit write data from the protocol chip C1 (110) to the area D1 of the cache 200 (S803). As described above, the area D1 of the cache 200 corresponds to the storage device 500A (D1). In this case, the MPC1 (130) obtains an address and a transmission length of the area D1.

The DMA circuit C1 (120) transmits the write data to the area D1 of the cache 200 depending on the instruction from the MPC1 (130) (S804). When the transmission of the written data is complete, the DMA circuit C1 (120) reports the completion of transmission to the MPC1 (130) (S805).

If receiving the completion of transmission of the data to the cache 200 from the DMA circuit C1 (120), the MPC1 (130) registers a message which includes an instruction to write the written data stored in the area D1 of the cache 200 into the storage device D1 (S806) in the message area 310 stored in the shared memory 300. In detail, the MPC1 (130) registers information such as an address of the area D1 obtained by the processing at the step S803 and the transmission length and soon, in the message table 320 and the request-response content table 330.

The MPC1 (130) instructs the protocol chip C1 (120) to transmit a writing-completion status to the host computer 10 (S807).

If receiving the instruction to transmit the writing-completion status, the protocol chip C1 (120) transmits the writing-completion status to the host computer 10 (S808).

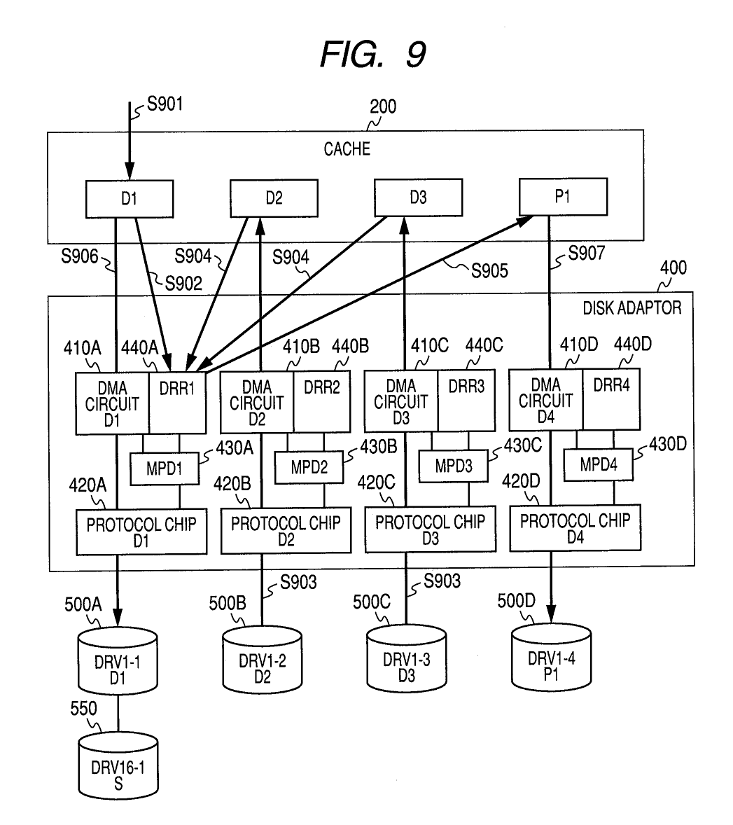

Herein, a processing of writing data into the storage devices 500 from the disk adaptor 400 will be described in brief with reference to FIG. 9. The processing shown in FIG. 9 is performed, after registering the message including the writing instruction of data, in the message area 310 of the shared memory 300 by the processing at the step S806 in FIG. 8.

FIG. 9 is a diagram to describe a processing to write data into the storage devices 500 according to the first embodiment of the present invention. In addition, an arrow with bold line represents a flow of data.

In FIG. 9, the channel adaptor 100 accepts a request of writing data into the storage device D1 (500A) and the written data is stored in the cache 200 (S901).

If the MPD1 (430A) detects the message including the writing request of data from the shared memory 300, it instructs the DRR1 (440A) to create a parity data (S902).

The DRR1 (440A) makes a request for obtaining data stored in the storage device 500B (D2) and the storage device 500C (D3) in order to create a parity data. The DMA circuits D2 (410B) and D3 (410C) read the requested data and write the read data into the areas D2 and D3 of the cache 200 corresponding to the storage devices where the data has been stored (S903).

The DRR1 (440A) obtains the data stored in the cache 200 (S904) and creates a parity data. The DRR1 (440A) writes the created parity data into the area P1 corresponding to the cache 200 (S905).

Lastly, the DMA circuit D1 (410A) writes the written data into the storage device D1 (500A) (S906). The DMA circuit D4 (410D) then writes the created parity data into the associated storage device P1 (500D) (S907).

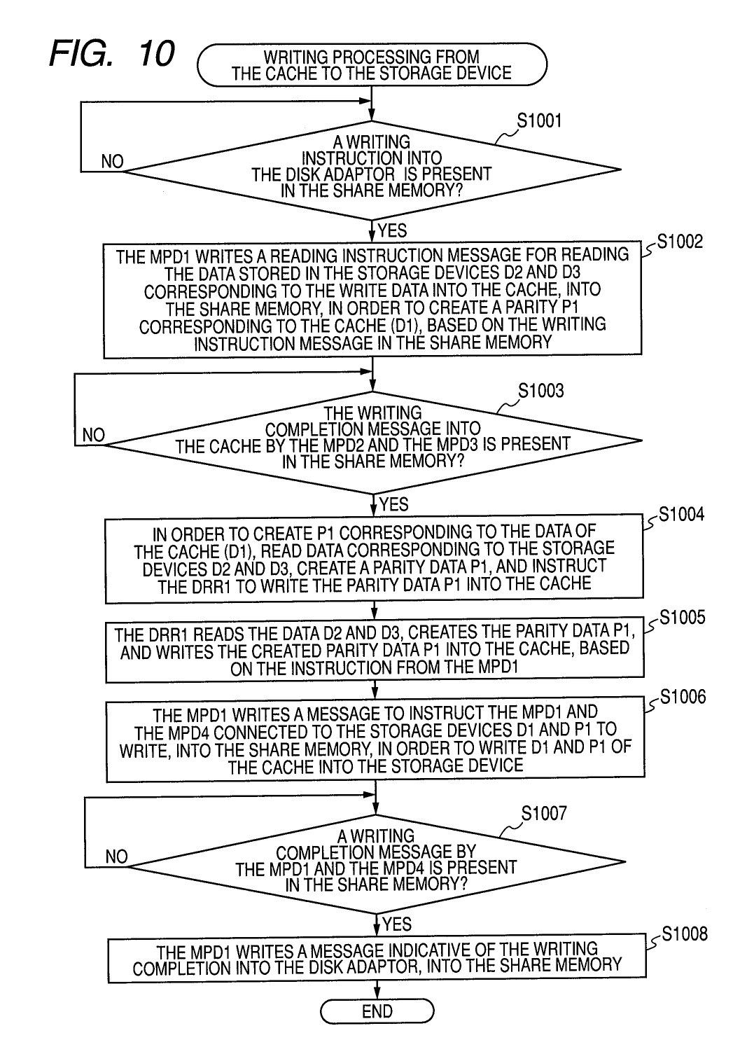

FIG. 10 represents the respective processings described in FIG. 9 as a flowchart, which will be described more in detail.

FIG. 10 is a flowchart to illustrate the order of writing the message into the shared memory 300, in order to store the data stored in the cache 200 into the storage devices 500, according to the first embodiment of the present invention.

The MPD1 (430A) of the disk adaptor 400 periodically determines whether or not a message including a writing instruction of data into the storage devices 500 managed by the MPD1 (430A) is stored in the shared memory 300 (S1001). Herein, the MPD1 (430A) determines whether or not a message including a writing instruction of data into the storage device D1 (500A) is stored in the shared memory 300. If a writing instruction of data is not stored in the shared memory 300 (a result at the step S1001 is “N”), it stands by until a message including a writing instruction of data is registered in the shared memory 300.

If a writing instruction of data is stored in the shared memory 300 (a result at the step S1001 is “Y”), the MPD1 (430A) reads out associated data stored in the storage devices D2 (500B) and D3 (500C) into the cache 200 (S1002). In detail, a reading instruction message for reading the data stored in the storage devices D2 (500B) and D3 (500C) corresponding to the write data, into the cache 200, is written into the shared memory 300, in order to update a parity data to be changed by a writing of the data.

The MPD1 (430A) stands by until the data stored in the storage devices D2 (500B) and D3 (500C) are written into the cache 200 by the MPD2 (430B) and the MPD3 (430C), based on the reading instruction message that has been written into the shared memory 300 at the step S1002 (S1003). When the data stored in the storage devices D2 (500B) and D3 (500C) are written, the MPD1 (430A) instructs the DRR1 (440A) to create a parity data (S1004).

The DRR1 (440A) reads data stored in the areas D1, D2 and D3 of the cache 200 and creates the parity data based on the content instructed by the processing at the step S1004. Further, the DRR1 (440A) instructs to write the created parity data into the area P1 of the cache 200 (S1005).

The MPD1 (430A) writes a message including a writing instruction for the MPD1 (430A) and the MPD4 (430D) into the shared memory 300, in order to write the data stored in the area D1 and the area P1 of the cache 200 into the storage devices 500A and 500D (S1006).

The MPD1 (430A) stands by until the data stored in the area D1 and the area P1 of the cache 200 is written into the storage devices 500A and 500D (S1007). After completion of writing the data, the MPD1 (430A) writes a message indicative of the writing completion for the writing instruction obtained by the processing at the step S1001, into the shared memory 300 (S1008).

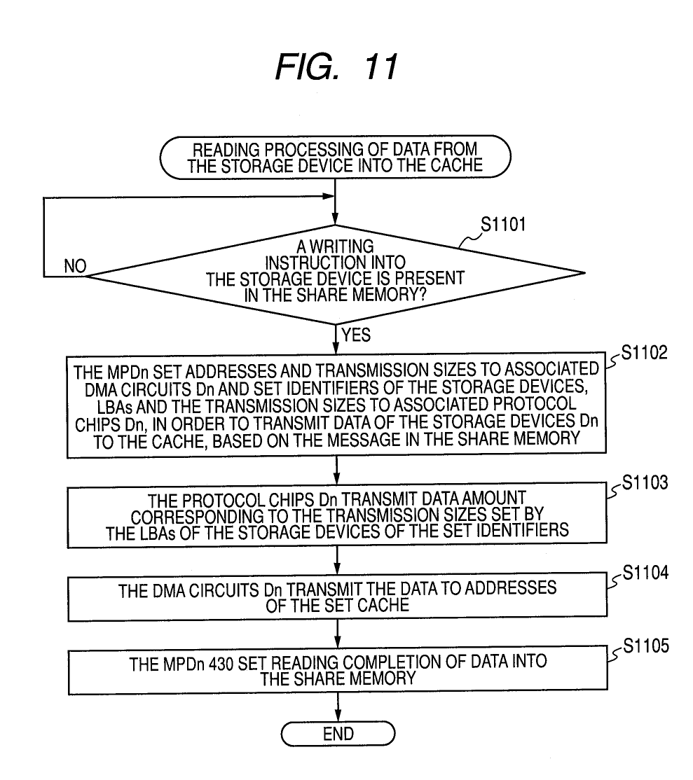

FIG. 11 is a flowchart to illustrate an order of reading the data stored in the storage devices 500 into the cache 200, based on the message stored in the shared memory 300, according to the first embodiment of the present invention.

This processing is performed when the data stored in the storage devices 500 are read into the cache 200 in a case of creating a parity data or the like. In addition, a message required for reading the data is stored in the message area 310 of the shared memory 300 in advance, and the MPs 430 of the disk adaptor 400 detect the message to perform this processing.

The MPDn (n: 1 to 4) 430 determine whether or not a message including a reading instruction of data stored in the storage devices 500 corresponding to the disk adaptor 400 is stored in the message area 310 of the shared memory 300 (S1101).

If a message including a reading instruction of data is stored therein (a result at the step S1101 is “Y”), the MPDn 430 set addresses and transmission sizes to associated DMA circuits Dn 410. Thereafter, identifiers of the storage devices 500, LBAs (Logical Block Addresses) and the transmission sizes are set to associated protocol chips Dn (S1102).

The protocol chips Dn 420 transmit data amount corresponding to the transmission sizes set by the LBAs of the storage devices 500 of the set identifiers (S1103).

The DMA circuits Dn 410 transmit the data transmitted from the protocol chips Dn 420 to addresses of the set cache 200 (S1104).

The MPDn 430 writes a message indicative of a reading completion for the reading instruction obtained by the processing at the step S1101 into the shared memory 300, after the reading completion (S1105).

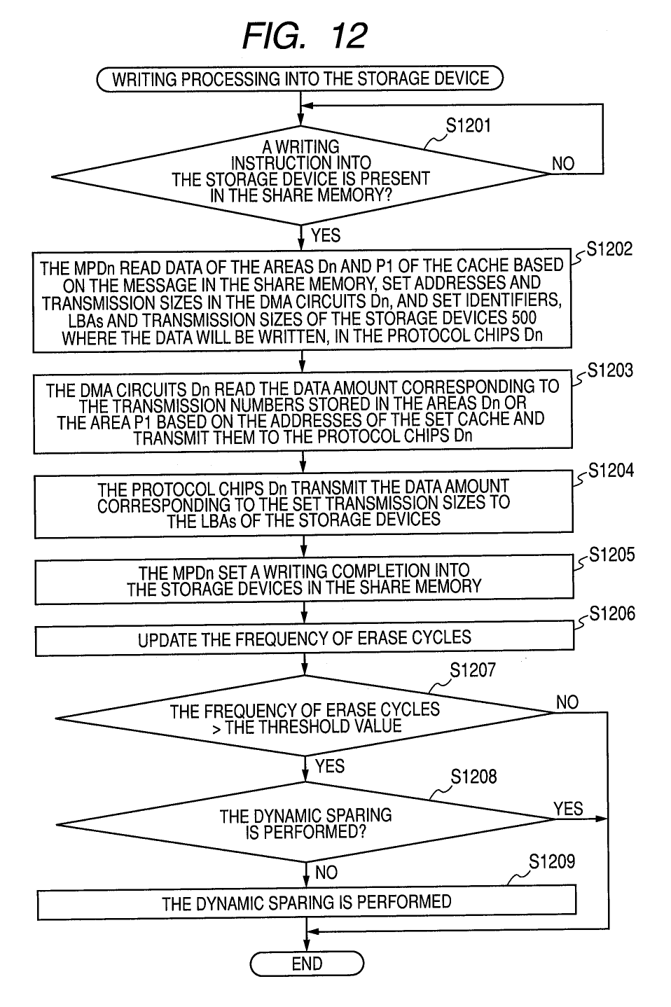

FIG. 12 is a flowchart to illustrate an order of writing the data stored in the cache 200 into the storage devices 500 based on the message stored in the shared memory 300 according to the first embodiment of the present invention.

This processing is based on the message including the writing instruction stored in the message area 310 of the shared memory 300 by the processing at the step S1006 in FIG. 10.

The MPDn 430 determine whether or not the message including a writing instruction of data stored in the cache 200 into the storage devices 500 is stored in the message area 310 of the shared memory 300 (S1201).

If the message including a writing instruction of data into the storage devices 500 is stored therein (a result at the step S1201 is “Y”), the MPDn 430 read the write data from the cache 200 based on the corresponding message. In order to write the data into the associated storage devices 500, the MPDn 430 set addresses and transmission sizes in the DMA circuits Dn 410 and instruct to transmit them to the protocol chips Dn 420. The MPDn 430 set identifiers, LBAs and transmission sizes of the storage devices 500 where the data will be written, in the protocol chips Dn 420, and instruct to transmit them to the storage devices 500 (S1202).

The DMA circuits Dn 410 read the data amount corresponding to the transmission numbers stored in the areas Dn or the area P1 based on the addresses of the cache 200 set by the processing at the step S1202 and transmit them to the protocol chips Dn 420 (S1203).

If receiving the transmission data from the DMA circuits Dn 410, the protocol chips Dn 420 transmit the data amount corresponding to the transmission sizes set by the processing at the step S1202 based on the set storage devices 500 and the LBAs (S1204).

The MPDn 430 writes a message indicative of the writing completion into the storage devices 500, into the message area 310 of the shared memory 300 (S1205).

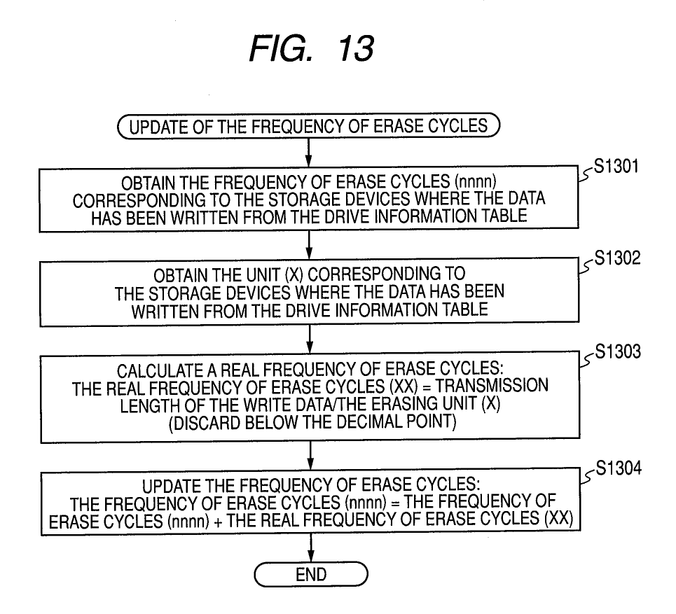

In the first embodiment, since the storage devices 500 is the SSD, after once erasing an area where data is stored, the data is written thereinto. Upon completion of writing the data into the storage devices 500, the MPDn 430 update the number of erasures 365 of the entries of the drive information table 360 corresponding to the storage devices 500 where the data has been written (S1206). An order of updating the number of erasures 365 will be described with reference to FIG. 13.

FIG. 13 is a flowchart to illustrate an order of updating the number of erasures 365 of the drive information table 360 according to the first embodiment of the present invention.

The MPDn 430 first obtain the number of erasures 365 corresponding to the storage devices 500 where the data has been written from the drive information table 360 (S1301). Subsequently, the MPDn 430 obtain the erasing unit 366 corresponding to the storage devices 500 where the data has been written from the drive information table 360 (S1302).

As described above, in a case of writing data, an area of a predetermined unit (the erasing unit 366) is erased in the SSD. Thus, when writing data of transmission length set in the storage device 500, the erasing is performed only as many times in frequency as dividing the transmission length of the written data by the erasing unit 366 (round up below decimal point).

Thus, the MPDn 430 divides the transmission length of the write data by the erasing unit 366 and calculates the frequency of rounding up below the decimal point as the real number of erasures (S1303). The MPDn 430 adds the real number of erasures to the number of erasures 365 and updates it as a new number of erasures 365 (S1304).

Now, the description returns to the flowchart in FIG. 12.

The MPDn 430 compares the updated number of erasures 365 with the threshold value N2 (355) (S1207). The threshold value N2 (355) is a value set for each RAID group as described above, and, whenever the number of erasures of the storage device 500 exceeds the threshold value N2 (355), data stored in the storage devices 500 are transferred to the spare storage device 550 (dynamic sparing) to make the number of erasures of the storage devices 500 configuring the RAID group uniform. Therefore, when the updated number of erasures 365 exceeds the threshold value N2 (355) (a result at the step S1207 is “Y”), the dynamic sparing is performed.

The MPDn 430 determines whether or not the dynamic sparing has been performed already for the storage device 500 which is a target of the dynamic sparing, before performing the dynamic sparing (S1208). This is because the storage device 500 in a process of performing the dynamic sparing is updated and possibly becomes a target of the dynamic sparing again. In a case of performing the dynamic sparing (a result at the step S1208 is “Y”), this processing is finished.

The MPDn 430 performs the dynamic sparing when the updated number of erasures 365 exceeds the threshold value N2 (355) and the dynamic sparing is not performed (a result at the step S1208 is “N”) (S1209).

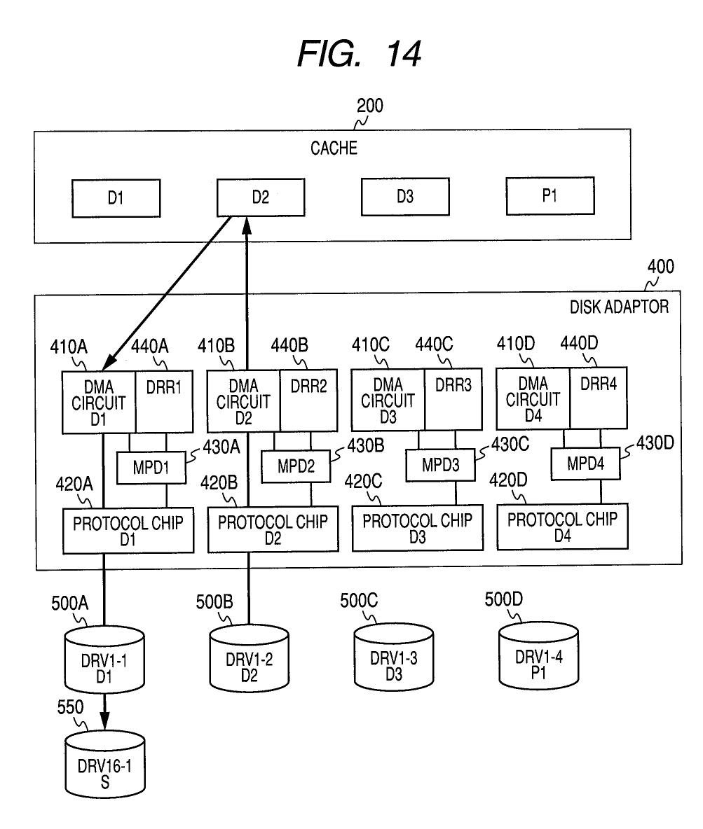

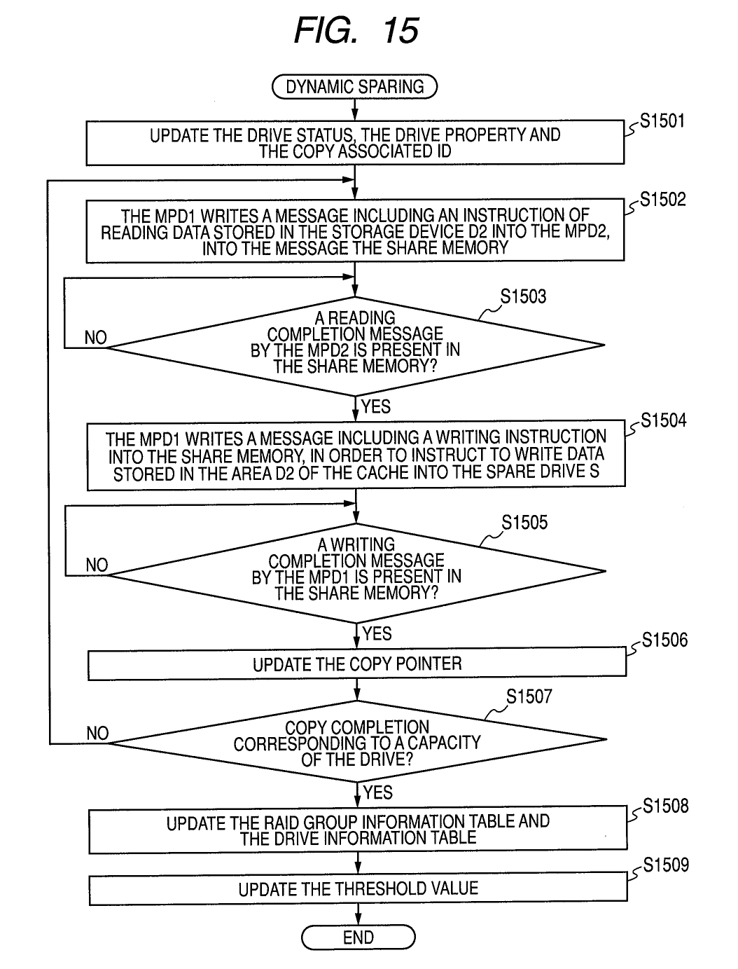

The dynamic sparing will be described in detail with reference to FIGS. 14 and 15.

FIG. 14 is a diagram to illustrate a flow of data upon performing the dynamic sparing according to the first embodiment of the present invention.

FIG. 14 illustrates a case of performing the dynamic sparing where the storage device D2 (500B) is copied to the spare storage device 550, as an example.

Once the dynamic sparing is performed, data stored in the storage device D2 (500B) is stored into the area D2 of the cache 200. Successively, the data stored in the area D2 of the cache 200 is transmitted to the spare storage device 550 by the DMA circuit 410A controlling the spare storage device 550.

FIG. 15 is a flowchart to illustrate an order of the dynamic sparing according to the first embodiment of the present invention.

The MPD1 (430A) updates the entries of the drive information table 360 corresponding to the storage device 500 which is a target of the dynamic sparing (S1501). In detail, the MPD1 (430A) changes the drive property 363 of the storage device D2 (500B) whose drive ID 361 is “DRV1-2” into “copy source” and changes the drive property 363 of the spare storage device 550 whose drive ID 361 is “DRV16-1” into “copy destination.” Further, the MPD1 (430A) changes the copy associated ID 364 whose drive ID 361 is “DRV1-2” into “DRV16-1” and changes the copy associated ID 364 whose drive ID 361 is “DRV16-1” into “DRV1-2.”

The MPD1 (430A) then writes a message into the message area 310 of the shared memory 300 in order to copy data of the storage device D2 (500B) to the spare storage device 550 (S1502) The message to be written includes an instruction for the MPD2 (430B) to read the data stored in the storage device D2 (500B) into the cache 200.

The MPD1 (430A) stands by until reading the data into the cache 200 by the MPD2 (430B) is completed (S1503). After completion of the reading the data into the cache 200 (a result at the step S1503 is “Y”), the MPD1 (430A) writes a message including a writing instruction into the message area 310 of the shared memory 300, in order to write the data read from the cache 200 into the spare storage device 550 (S1504).

The MPD1 (430A) stands by until writing the data into the spare storage device 550 is completed (S1505). If writing the data into the spare storage device 550 is completed (a result at the step S1505 is “Y”), the MPD1 (430A) updates the copy pointer 354 of the RAID group information table 350 (S1506).

The MPD1 (430A) carries out the processings at the steps S1502 to S1506 until copy of all the data is completed (S1507).

If the copy of all the data is completed (a result at the step S1507 is “Y”), the MPD1 (430A) updates the drive IDs (357 to 359) of the RAID group information table 350 (S1508). In detail, it updates a value of the drive ID2 (358) into “DRV16-1” which is the spare storage device. Further, the MPD1 (430A) updates the drive status 362, the drive property 363 and the copy associated ID 364 of the drive information table 360. Likewise, the MPD1 (430A) updates the DRVID1 (357) of “Spare” which is a value of the RAID group number 351 corresponding to the spare storage device 550, into “DRV2-1.”

Lastly, the MPD1 (430A) updates the threshold value N2 (355) of the RAID group information table 350 (S1509). In detail, the threshold value N2 becomes the threshold value N2+(the threshold value N1 (380)/the number of the component drives (356)). As above, by increase of the threshold value sequentially whenever the dynamic sparing is completed, the dynamic sparing can be performed for the storage devices 500 with a large number of erasures, although the dynamic sparing has been performed for all the storage devices 500 included in the storage system 20.

In this case, a processing of writing data into the storage device 500 for which the dynamic sparing is being performed will be described. Of the dynamic sparing, the flowchart shown in FIG. 8 and the processings up to the step S1005 of the flowchart shown in FIG. 10, that is, the processings from accepting the request to write data to writing the parity data into the cache 200 are the same as typical cases.

The MPD1 (430A) writes a message including a writing instruction of data into the message area 310 of the shared memory 300 in order to store the parity data stored in the cache 200 into the storage devices 500. In detail, the MPD1 (430A) writes the message into the message area 310 of the shared memory 300 such that the parity data stored in the cache 200 is written into the storage device P1 (500D) by the MPD4 (430D).

Then, the MPD1 (430A) calculates an address for writing the data stored in the area D1 of the cache 200 and compares it with the copy pointer 354 of the RAID group information table 350.

When the address for writing the data is smaller than the copy pointer, a message is written into the message area 310 of the shared memory 300 such that the data stored in the area D1 are written into both of the storage device D1 (500A) and the spare storage device 550. The message which will be written thereinto includes an instruction for the MPD1 (430A) controlling the storage device D1 (500A) and the spare storage device 550 to write the data into both of the storage device D1 (500A) and the spare storage device 550.

Processings thereafter are the same as the processings after the step S1007 of the flowchart shown in FIG. 10 and the typical orders illustrated in the flowcharts shown in FIGS. 11 and 12.

Lastly, an order of changing the storage devices 500 will be described. When the storage devices 500 are changed, and, if the threshold value N2 is the same as that before change in the RAID group including the changed storage device 500, the dynamic sparing is performed with difficulty, and the number of erasures among the storage devices 500 may be made un-uniform. Thus, the number of erasures of the storage devices 500 is required to be made uniform by initializing the threshold value N2 of the RAID group including the changed storage devices 500.

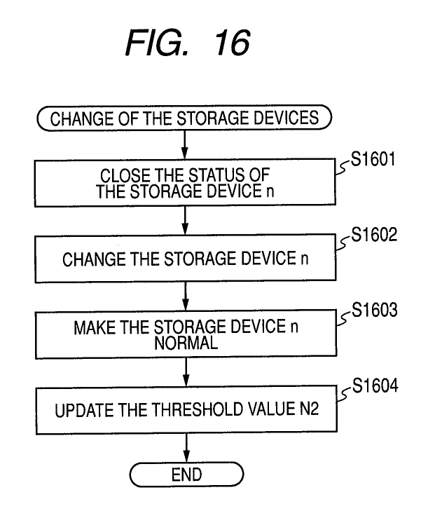

FIG. 16 is a flowchart to illustrate an order of changing the storage devices included in the storage system according to the first embodiment of the present invention.

When a storage device 500 to be separated for changing the storage devices 500 is designated, the MPD1 (430A) updates the drive status 362 of the entries of the drive information table 360 corresponding to the designated storage device into “Closed” (S1601). The separated storage device 500 may be one where an obstacle occurs or one of which the number of erasures exceeds a predetermined frequency.

The MPD1 (430A) further notifies the maintenance terminal 30 of changing the designated storage device, via the network 40. The designated storage device 500 is separated by a maintenance source referring to the maintenance terminal 30 and thus is changed into a new storage device 500 (S1602).

Once the change of the designated storage device 500 is completed, the MPD1 (430A) updates the drive status 362 of the corresponding storage device into “Normal” (S1603).

Lastly, the MPD1 (430A) updates the threshold value N2 (355) of the RAID group which the changed storage device 500 belongs to (S1604). In detail, the threshold value N2 (355) is initialized by dividing the threshold value N1 (380) by the number of the storage devices configuring the RAID group.

According to the first embodiment of the present invention, the number of writings (number of erasures) can be made uniform by performing the dynamic sparing of transferring data stored in a storage device with a large number of writings to the spare storage device. Therefore, even in the storage device with a limit of the number of writings such as the SSD, a lifetime of each storage device can be made uniform, to lengthen the lifetime of the entire storage system.

In addition, according to the first embodiment of the present invention, to make the lifetime of each storage device uniform enables the frequency of replacing the storage device to be lower, thereby reducing the operation cost.

Furthermore, according to the first embodiment of the present invention, a threshold value which is a criterion for performing the dynamic sparing for each RAID group is defined and is increased step by step, to prevent the dynamic sparing from being excessively performed for a RAID group with a large number of writings. Likewise, also in a case where the writing is concentrated on a specific storage device within the RAID group, the threshold value is increased step by step for each RAID group and thus the dynamic sparing can be prevented from being excessively performed for the specific storage device.

### Second Embodiment

Although the number of erasures for each storage device 500 has been configured to be recorded in the drive information table 360 of the configuration information area 340 in the first embodiment of the present invention, a case where the number of erasures is possible to be stored in the storage devices 500 will be described in the second embodiment.

Since each of the storage devices 500 records a number of erasures in the second embodiment of the present invention, the disk adaptor 400 collects the number of erasures of the storage device 500 periodically, independent from a writing processing of data, and the dynamic sparing can be performed. In addition, collected number of erasures of the storage device 500 is stored in the drive information table 360 included in the configuration information area 340.

In addition, in the second embodiment, the description of common contents with the first embodiment will be omitted properly.

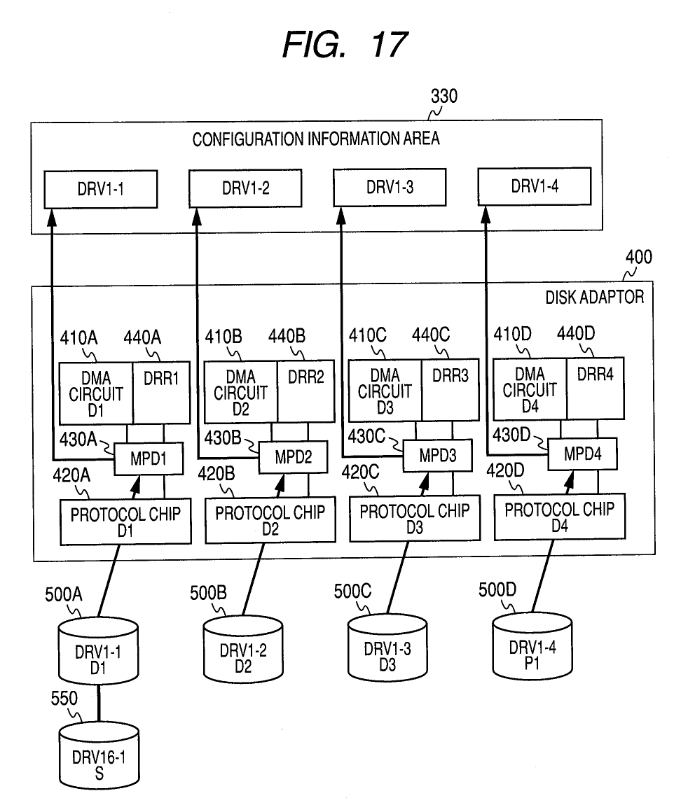

FIG. 17 is a diagram to illustrate an order of storing a number of erasures of each storage device 500 in the configuration information area 340 according to the second embodiment of the present invention.

The MPD1 (430A) instructs each RAID group to update an associated entry of the drive information table 360 together with a number of erasures stored in each storage device 500 periodically. In detail, the MPD1 (430A) writes a message including an instruction to update the number of erasures into the message area 310, obtains the number of erasures of the storage device 500 managed by the MP 430 included in the disk adaptor 400, and updates the associated entry of the drive information table 360.

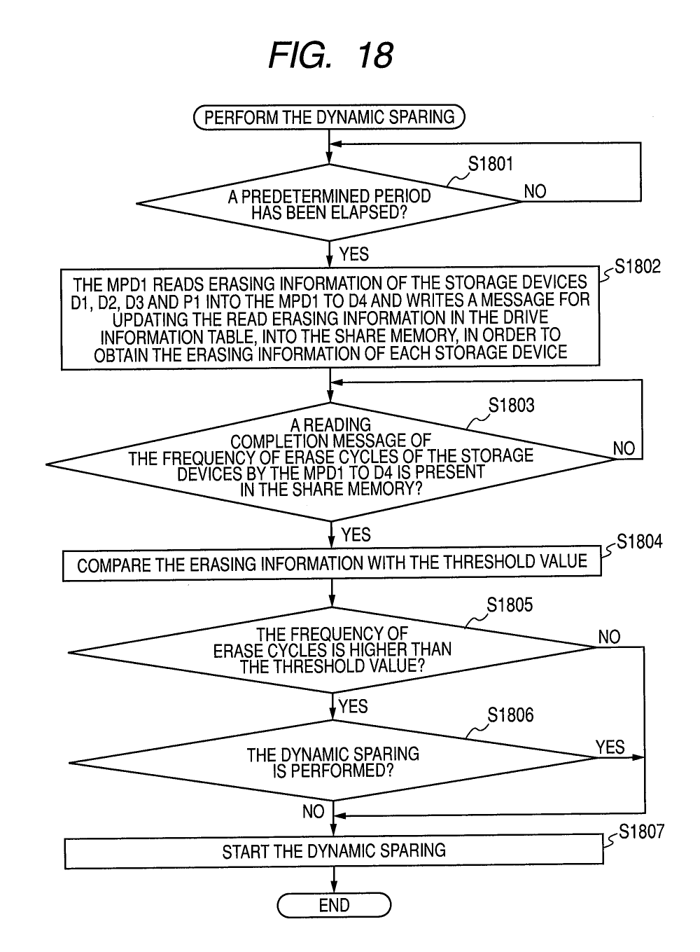

FIG. 18 is a flowchart to illustrate an order of performing the dynamic sparing according to the second embodiment of the present invention.

The MPD1 (430A) determines whether or not a predetermined period has been elapsed (S1801). If the predetermined period has been elapsed (a result at the step S1801 is “Y”), the MPD1 (430A) carries out processings posterior to the step S1802 and determines whether or not the dynamic sparing is performed.

The MPD1 (430A) writes a message including a reading instruction of the number of erasures into the message area 310 of the shared memory 300, in order to obtain the number of erasures of each storage device from the MPD1 to MPD4 (430A to 430D) to which the storage devices D1, D2, D3 and P1 (500A to 500D) are connected (S1802).

The MPD1 (430A) stands by until the number of erasures are read into the shared memory 300 by the MPD1 to MPD4 (430A to 430D) (S1803). If the reading the number of erasures of all the storage devices 500 is completed (a result at the step S1803 is “Y”), the MPD1 (430A) compares the number of erasures 365 and the drive information table 360 and the threshold value N2 (355) of the RAID group information table 350 (S1804).

If the storage device 500 whose number of erasures exceeds the threshold value N2 (355) is included in the RAID group (a result at the step S1805 is “Y”), the MPD1 (430A) determines whether or not the dynamic sparing is performed for the corresponding storage device 500 (S1806). If the dynamic sparing is not performed for the corresponding storage device 500 (a result at the step S1806 is “N”), the dynamic sparing is performed according to the flowchart shown in FIG. 15 (S1807).

In addition, the spare storage device 550 may be a spare storage device 550 common to the storage system 20, and the spare storage device 550 may be provided for each RAID group to make the number of erasures including the spare storage device 550 for each RAID group uniform.

According to the second embodiment of the present invention, the number of writings can be made uniform in a unit of the RAID group, like the first embodiment. Moreover, since the dynamic sparing is performed independent from the writing of data, a load at the time of the writing of data can be restricted.

### Third Embodiment

Although the dynamic sparing has been performed for each RAID group in the second embodiment of the present invention, the dynamic sparing is performed for a storage device 500 with a large number of erasures regardless of a RAID group which the storage devices 500 belong to, in the third embodiment.

In addition, in the third embodiment, the number of erasures is stored in each of the storage devices 500 and the dynamic sparing is performed independent from the writing processing of data, like the second embodiment.

In addition, in the third embodiment, the description of common contents with the first and the second embodiments will be omitted properly.

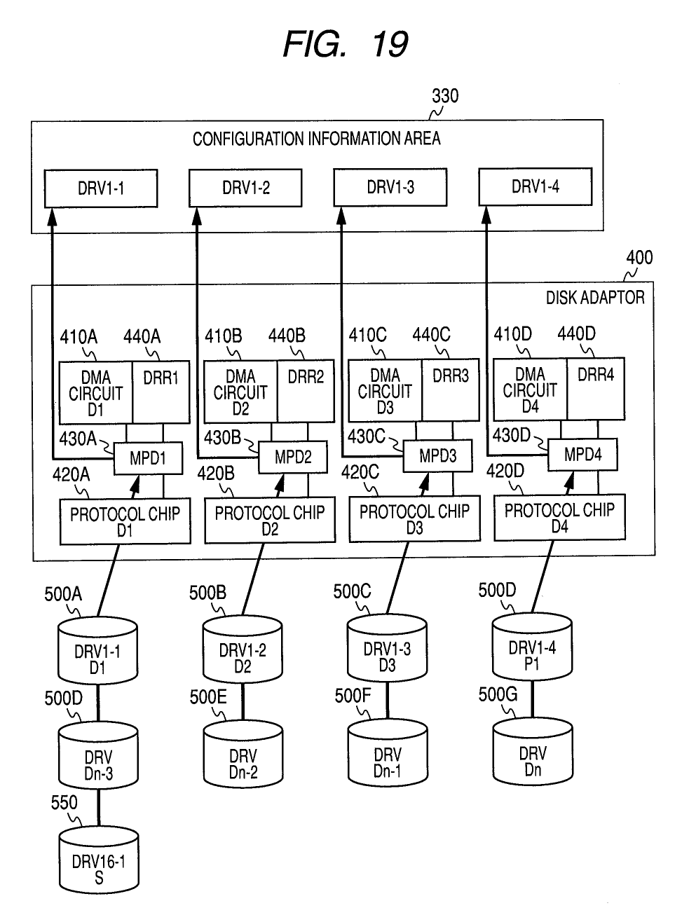

FIG. 19 is a diagram to illustrate an order of storing a number of erasures of each storage device 500 in the configuration information area 340 according to the third embodiment of the present invention.

The MPD1 (430A) instructs each RAID group to update an associated entry of the drive information table 360 together with a number of erasures stored in each storage device 500 periodically, like the second embodiment (FIG. 17). In the third embodiment of the present invention, the number of erasures of the storage devices 500 included in the storage system 20 is updated, respectively, regardless of the RAID groups.

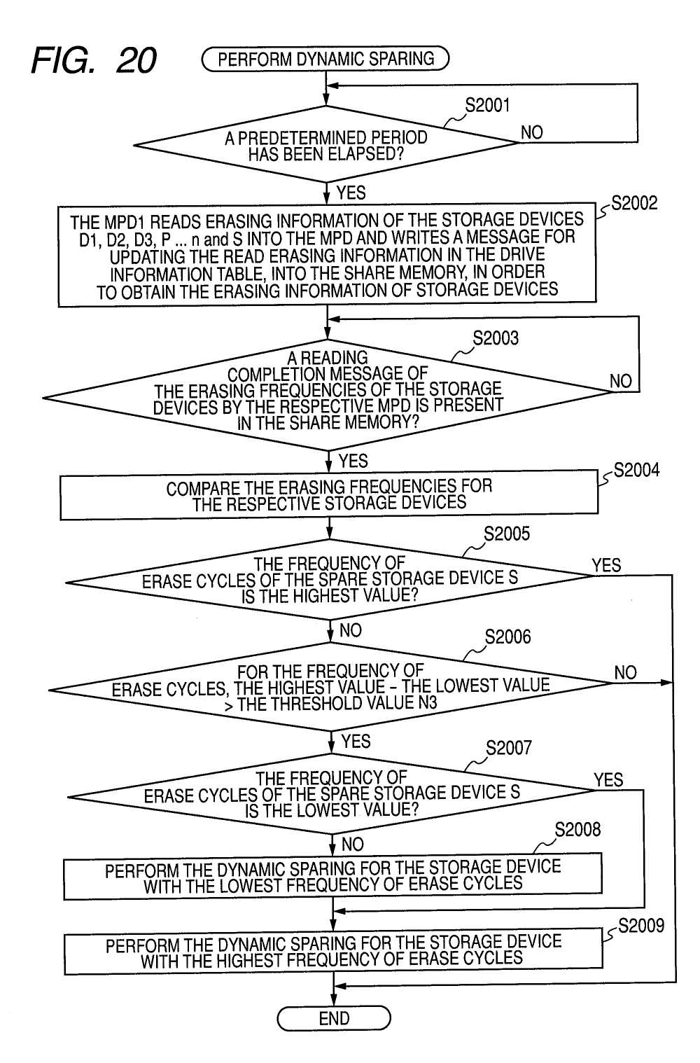

FIG. 20 is a flowchart to illustrate an order of performing the dynamic sparing according to the third embodiment of the present invention.

The MPD1 (430A) determines whether or not a predetermined period has been elapsed (S2001). If the predetermined period has been elapsed (a result at the step S2001 is “Y”), the MPD1 (430A) carries out processings posterior to the step S2002 and determines whether or not the dynamic sparing is performed.

The MPD1 (430A) writes a message including a reading instruction of the number of erasures into the message area 310 of the shared memory 300, in order to obtain the number of erasures of the respective storage devices 500 from the MPD1 to MPD4 (430A to 430D) to which all of the storage devices 500 are connected (S2002).

The MPD1 (430A) stands by until the number of erasures are obtained into the shared memory 300 by the respective MPs 430 (S2003). If the obtaining of the number of erasures of all the storage devices 500 is completed (a result at the step S2003 is “Y”), the MPD1 (430A) compares the number of erasures for the respective storage devices 500 (S2004).

The MPD1 (430A) determines whether or not the number of erasures of the spare storage device 550 is the highest value of the number of erasures of the storage devices 500 read by the respective MPs 430 (S2005). If the number of erasures of the spare storage device 550 is the highest value (a result at the step S2005 is “Y”), this processing is finished without performing the dynamic sparing.

On the other hand, if the number of erasures of the spare storage device 550 is not the highest value (a result at the step S2005 is “N”), the MPD1 (430A) compares a difference between the maximum and the minimum of the read number of erasures with the threshold value N3 (390) (S2006).

If the difference between the highest and the lowest values of the number of erasures of the respective storage devices 500 is lower than the threshold value N3 (390) (a result at the step S2006 is “N”), this processing is finished since a difference between the number of erasures of the respective storage devices 500 can be judged to be small and be uniform in MPD1 (430A).

If the difference between the highest and the lowest values of the number of erasures of the respective storage devices 500 is higher than the threshold value N3 (390) (a result at the step S2006 is “Y”), the dynamic sparing is performed since the number of erasures of the respective storage devices are not uniform in MPD1 (430A).

The MPD1 (430A) determines whether or not the number of erasures of the spare storage device 550 is the lowest value (S2007). If the number of erasures of the spare storage device 550 is the lowest value (a result at the step S2007 is “Y”), the dynamic sparing is performed between it and the storage device 500 whose number of erasures is the highest value (S2009).

In contrast, if the number of erasures of the spare storage device 550 is not the lowest value (a result at the step S2007 is “N”), in order to perform the dynamic sparing between the storage device with the lowest number of erasures and the storage device with the highest number of erasures, the dynamic sparing is first performed between the storage device 500 with the lowest number of erasures and the spare storage device 550 (S2008) in MPD1 (430A). Thereafter, the dynamic sparing is performed between the spare storage device 550 and the storage device 500 with the highest number of erasures (S2009). For example, when the number of erasures of the storage device D2 (500B) is the highest value and the number of erasures of the storage device D1 (500A) is the lowest value, the dynamic sparing is first performed between the storage device D1 (500A) and the spare storage device 550. As a result, data stored in the storage device D1 (500A) is stored into the spare storage device 550 and information stored in the configuration information area 340 is updated. The dynamic sparing can be performed between the storage device D1 (500A) and the storage device D2 (500B), by performing the dynamic sparing between the spare storage device which was the storage device D1 originally and the storage device D2 (500B).

In addition, the dynamic sparing based on the threshold value N2 set for each RAID group may be performed together therewith, or only the dynamic sparing based on the highest value and the lowest value of the number of erasures of the storage devices 500 may be performed by setting the threshold value N2 to a sufficiently large value.

According to the third embodiment of the present invention, since all of the storage devices included in the storage system can be made uniform together with the effect of the first embodiment, the lifetime of the storage system can be lengthened more.

What is claimed is:

1. A storage system for storing data, comprising:
an interface; a processor connected to the interface; a memory connected to the processor; and a plurality of storage devices for storing the data,
wherein the plurality of storage devices comprise spare storage devices,
the memory stores an identifier of each of the storage devices and storage device configuration information having a number of erasures of data in which the data stored in each storage device was erased, and
the processor copies data stored in a storage device whose number of erasures of data exceeds a predetermined first threshold value to the spare storage device in a case where the number of erasures of data exceeds the predetermined first threshold value, and allocates an identifier of the storage device whose number of erasures of data exceeds the predetermined first threshold value to an identifier of the spare storage device which the data has been copied to.

2. The storage system according to claim 1, wherein the processor adds a predetermined value to the predetermined first threshold value, to update the predetermined first threshold value, in a case where the number of erasures of data exceeds the predetermined first threshold value.

3. The storage system according to claim 2, wherein the processor initializes the updated predetermined first threshold value, in a case where a storage device included in the plurality of storage devices is closed and the closed storage device is changed with a new storage device.

4. The storage system according to claim 1, wherein the processor updates the number of erasures of data whenever the data stored in the storage device is erased.

5. The storage system according to claim 1, wherein the data is stored with redundancy by the plurality of storage devices configuring RAID groups, and
the predetermined first threshold value is set for each RAID group.

6. The storage system according to claim 1, wherein the number of erasures of data of the corresponding storage device is recorded in the storage device, and
wherein the processor collects the number of erasures of data of each of the storage devices from the plurality of storage devices, and compares the collected number of erasures of data with the predetermined first threshold value periodically.

7. The storage system according to claim 1, wherein the processor obtains the highest value and the lowest value of the number of erasures of data of the plurality of storage devices, changes data stored in a storage device whose number of erasures of data is the highest value with data stored in a storage device whose number of erasures of data is the lowest value in a case where a difference between the highest value and the lowest value of the number of erasures of data is higher than a predetermined second threshold value, and changes an identifier of the storage device whose number of erasures of data is the highest value with an identifier of the storage device whose number of erasures of data is the lowest value.

8. The storage system according to claim 1, wherein the storage device is configured of a semiconductor storage device, and
wherein, in a case where data is written into an area where data is stored, the processor erases the area where data is stored by a predetermined unit and writes data into the erased area.

9. A configuration managing method for managing a configuration of a storage device storing data in a storage system for storing the readable and writable data,
wherein the storage system comprises: an interface; a processor connected to the interface; a memory connected to the processor; and the plurality of storage devices, and
wherein the plurality of storage devices comprise spare storage devices,
the memory stores an identifier of each of the storage devices and storage device configuration information having a number of erasures of data that data stored in each storage device is erased, and
the processor copies data stored in a storage device whose number of erasures of data exceeds a predetermined first threshold value to the spare storage device in a case where the number of erasures of data exceeds the predetermined first threshold value, and allocates an identifier of the storage device whose number of erasures of data exceeds the predetermined first threshold value to an identifier of the spare storage device which the data has been copied to.

10. The configuration managing method according to claim 9, wherein the processor adds a predetermined value to the predetermined first threshold value, to update the predetermined first threshold value, in a case where the number of erasures of data exceeds the predetermined first threshold value.

11. The configuration managing method according to claim 10, wherein the processor initializes the updated predetermined first threshold value, in a case where a storage device included in the plurality of storage devices is closed and the closed storage device is changed with a new storage device.

12. The configuration managing method according to claim 9, wherein the processor updates the number of erasures of data whenever the data stored in the storage device is erased.

13. The configuration managing method according to claim 9, wherein the data is stored with redundancy by the plurality of storage devices configuring RAID groups, and
the predetermined first threshold value is set for each RAID group.

14. The configuration managing method according to claim 9, wherein the number of erasures of data of the corresponding storage device is recorded in the storage device, and
wherein the processor collects the number of erasures of data of each of the storage devices from the plurality of storage devices, and compares the collected number of erasures of data with the predetermined first threshold value periodically.

15. The configuration managing method according to claim 9, wherein the processor obtains the highest value and the lowest value of the number of erasures of data of the plurality of storage devices, changes data stored in a storage device whose number of erasures of data is the highest value with data stored in a storage device whose number of erasures of data is the lowest value in a case where a difference between the highest value and the lowest value of the number of erasures of data is higher than a predetermined second threshold value, and changes an identifier of the storage device whose number of erasures of data is the highest value with an identifier of the storage device whose number of erasures of data is the lowest value.
